(19) United States
(12) Patent Application Publication
(10) Pub. No.: US 2004/0183299 A1
(43) Pub. Date: Sep. 23, 2004

(54) Hose-clamp, method for manufacturing of the clamp and use of such a clamp

(76) Inventor: Rickard Svensson, Vaggeryd (SE)

Correspondence Address: PEARNE & GORDON LLP, 1801 EAST 9TH STREET, SUITE 1200, CLEVELAND, OH, 44114-3108, US

(21) Appl. No.: 10/474,574

(22) PCT Filed: Apr. 10, 2002
(86) PCT No.: PCT/SE02/00704

(30) Foreign Application Priority Data
Apr. 11, 2001 (SE) 0101283-0

(51) Int. Cl. F16L 33/00

(52) U.S. Cl. 285/256; 285/242

(57) ABSTRACT

Clamp (10, 20, 30) for connecting a hose (13, 23, 33) to a pipe end (14, 24, 34) with an asymmetric cross section. The clamp (10, 20, 30) comprises at least two sections (11 and 12, 21 and 22, 31 and 32) that are shaped so that the clamp (10, 20, 30) will have the same shape as the cross section of the pipe end (14, 24, 34) when the two sections are put together. The clamp (10, 20, 30) is made of aluminium or a plastic material.

The claimed invention relates to a clamp for fastening of a hose to a pipe end.

There are several different types of hose clamps on the market today. The known types of clamps are available in a lot of different embodiments and materials in order to adapt the clamp to a specific purpose. The material in the clamp can for example be a plastic material or a metal.

The designs of the different clamps can vary between a traditional hose clamp that is tightened by a screwdriver and a disposable camp made of a plastic material and secured around the hose by connecting jaws that are hooked to each other when they are pressed together. The first type is illustrated and described in for example the patent document SE307708 and the second type in U.S. Pat. No. 1,368,068.

However, the hose clamps available on the market will not be able to attach a hose to a pipe end with an asymmetrical cross section so that the connection is properly sealed. The problem is that the asymmetrically shaped pipe end will make it impossible for the known clamps to apply a pressure around the entire circumference of the hose and the pip end so that the connection is sealed. This is a result of the known clamps since they only will put enough pressure on some parts of the circumference of the hose to seal the connection because of the asymmetric shape of the pipe end.

A clamp for attaching a hose to a pipe end with an asymmetrical cross section is not known or illustrated in the prior are. The clamp must also be easy to manufacture, resistible to high temperatures, easy for the operator to attach is not known in the prior art. It must also be possible to attach the clamp to the hose and pipe end even though the space for the clamp as well as for the person who is putting the different parts together is limited.

The claimed clamp, with the features that are defined in the claims, solves the problems described above.

The new clamp comprises two different parts. De two parts are two stiff sections shaped so that they, when they are connected to each other, makes a clamp with a shape that matches the shape of the cross section of the pipe end that the hose is supposed to be attached to. The shape of the clamp is designed to match the cross-section of the pipe so that the clamp will lie close to almost the entire circumference of the pipe end.

The shape of the sections causes a pressure that will be applied on the hose and the pipe end when the clamp is secured around the hose and the pipe end. The pressure will be spread along almost the entire circumference of the hose and the pipe end because of the stiff sections even though the pipe end has an asymmetric cross section. The clamp therefore provides a reliable sealing between the asymmetric pipe end and the hose.

This new clamp is useful for a lot of different cross sections since the design of the two sections can be adapted to match the cross section of the pipe end. The new type of clamp will work properly even if the circumference of the pipe or hose have sections with a convex shape alternating with sections with a concave shape as long as the two sections have the right shape for the specific cross section.

The different parts of the clamp are in one end shaped so that they can be hooked together. After that are the clamp placed around the hose that is placed on the asymmetric pipe end. One of the sections is in the other end shaped like a hook, while the other section is provided with a protruding part in the end. When the two sections of the clamp are pressed together around the hose and the pipe end with an appropriate tool will the hook secure to the protruding part so that the clamp is sealed.

The clamp defined in the claims is easy and fast to attach and small in relation to other hose clamps available on the market, which means that it not needs a lot of space to attach the hose to the pipe end.

Another advantaged with the claimed clamp is that it not has to be put around the hose before the hose is placed on the pipe end, which will increase the flexibility during mounting.

The clamp is suitable for use in environments where the space is limited like for example in a chain saw for sealing the connection of a hose to an air inlet to the cylinder in the engine. The clamp defined by the claims makes it possible to replace a complicated solution where the hose end is provided with a rubber flange that is secured to the cylinder inlet by a screw by a hose that is put on an asymmetric pipe end connected to the cylinder inlet. The hose is secured to the pipe end by a clamp as the one defined by the claims so that a pressure is applied around almost the entire circumference of the hose.

The two sections of the clamp are made of aluminium or a plastic material that has a high strength and low weight. A clamp made of aluminium is favourable in applications where the clamps will be exposed to high temperatures.

The manufacturing of the two aluminium or plastic sections is made by extrusion. The manufacturing starts with heating of the material. When the right temperature is reached is the material pressed through a tool so that a profile with the same shape as the shape of the sections is made. In order to make the manufacturing effective is long profiles extruded at the same time. The profile is finally cut into sections with a length that equals the width of the clamp. The manufacturing of the clamp is therefor fast and very economical.

Three different embodiments of the claimed clamp are illustrated in the figures.

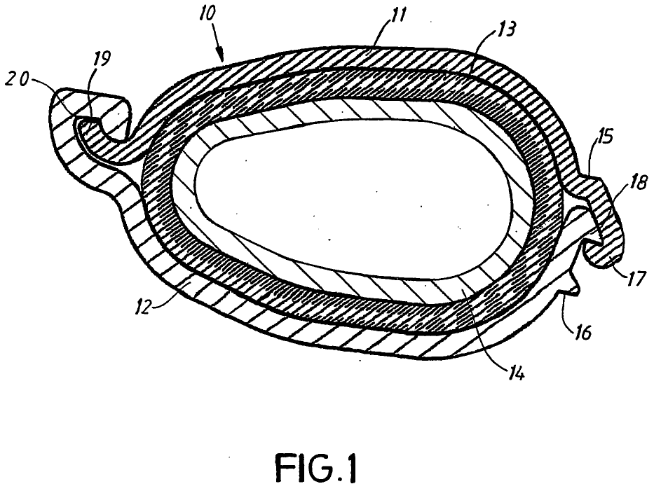

FIG. 1. Illustrates a cross section of a hose secured to an asymmetrical pipe end by a clamp.

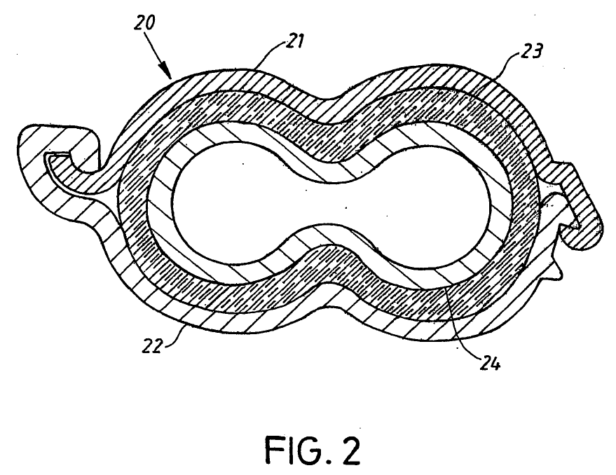

FIG. 2. Illustrates a cross section of a hose secured to an asymmetrical cross section with a circumference with alternating concave and convex sections by a clamp.

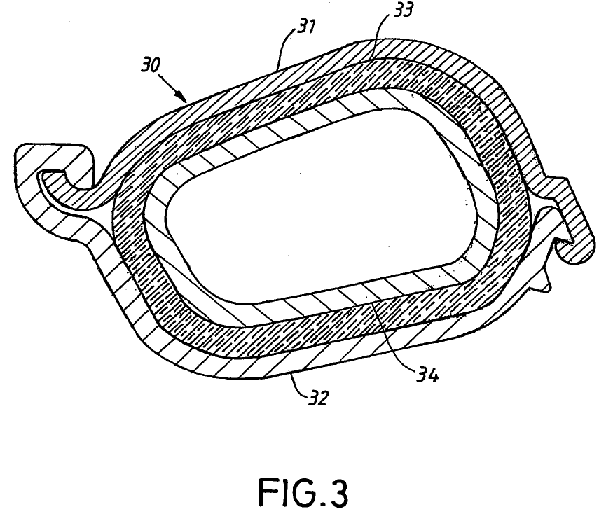

FIG. 3. Illustrates a third embodiment of a hose secured to an asymmetrical pipe end by a clamp.

The clamp 10 comprises two different sections 11 and 12. The sections 11 and 12 are in one of the ends shaped so that they can be connected. This is done by a protruding part 19 on one section 11 that is put in a trace 20 in one end of the section 12. The clamp 10 is then placed around a 13 that is put on an asymmetric pipe end 14. When the hose 13 and the clamp 10 are in the right position in relation to the asymmetric pipe end 14 is the clamp 10 pressed together by a tool that is pressing on a first protruding part 15 on the first section 11 and a second protruding part 16 on the second section 12. The first section 11 is provided with a hook 17 and the second section is provided with a third protruding part 18. When the two sections 11 and 12 are pressed together will the hook 17 attach to the third protruding part 18 so that the clamp 10 is secured around the hose 13 and the asymmetric pipe end 14.

The two sections 11 and 12 are manufactured by extrusion of an aluminium or plastic material into long profiles. The profiles are cut so that the sections 11 and 12 get the desired width.

In FIG. 2 is a second embodiment of a clamp 20 illustrated. The clamp 20 still comprises two sections 21 and 22 but the clamp 20 is designed for securing of a hose 23 to a pipe end 24 with a cross section with alternating concave and convex sections. The two sections 21 and 22 are fastened to each other in the same way as in the first embodiment.

The third embodiment of a clamp 30 that is illustrated in FIG. 3 is designed for securing of a hose 33 to a pipe end 34 with another type of asymmetric cross section. The clamp 30 comprises two sections 31 and 32 that are shaped so that the clamp 30 will have the same shape as the cross section of the pipe end 34. The two sections 31 and 32 are fastened to each other in the same way as in the first embodiment.

1. Clamp (10, 20, 30) for sealing and connection of a hose (13, 23, 33) to a pipe end (14, 24, 34) with an asymmetrical cross section, characterised in that the clamp (10, 20, 30) comprises at least two sections (11 and 12, 21 and 22, 31 and 32) shaped so that the clamp (10, 20, 30) will have the same shape as the asymmetrical cross section of the pipe end (14, 24, 34) so that a pressure is applied on the hose (13, 23, 33) and the pipe end (14, 24, 34) around almost the entire circumference of the hose (13, 23, 33) and the pipe end (14, 24, 34).

2. Clamp (10, 20, 30) according to claim 1, characterised in that the clamp consists of two sections (11 and 12, 21 and 22, 31 and 32).

3. Clamp (10, 20, 30) according to claim 1 or 2, characterised in that the sections (11 and 12, 21 and 22, 31 and 32) are stiff.

4. Clamp (10, 20, 30) according to claim 1, 2 or 3, characterised in that the sections (11 and 12, 21 and 22, 31 and 32) are made of aluminium or a plastic material.

5. Clamp (10, 20, 30) according to claim 2, characterised in that the sections (11 and 12, 21 and 22, 31 and 32) are shaped so that can be attached to each other in one end.

6. Clamp (10, 20, 30) according to claim 6, characterised in that the other end of the sections are shaped so that they will secure to each other when the clamp is pressed around the hose (13, 23, 33) and the pipe end (14, 24, 34).

7. Clamp (10, 20, 30) according to claim 7, characterised in that the sections (11 and 12, 21 and 22, 31 and 32) are provided with protruding parts (15 and 16) so that the two sections (11 and 12) can be pressed together by a tool that supports on the protruding parts (15 and 16)

8. Clamp (10, 20, 30) according to any of the previous claims, characterised in that the sections (11 and 12, 21 and 22, 31 and 32) have a rectangular cross section.

9. Method for manufacturing of a clamp (10, 20, 30) according to any of the claims 1-10, comprising the following steps;
extrusion of two aluminium or plastic profiles with a cross section that equals the shape of the two sections (11 and 12, 21 and 22, 31 and 32) in the clamp (10, 20, 30).
cutting of the profiles in sections with a length that is the same as the desired width of the clamp (10, 20, 30).

10. Use of a clamp (10, 20, 30) according to any of the claims 1-8, characterised in that the clamp (10, 20, 30) is used for sealing a connection of a hose (13, 23, 33) to an air inlet to a cylinder in an engine that powers a chain saw.
